(19) United States
(12) Patent Application Publication
(10) Pub. No.: US 2010/0247890 A1
(43) Pub. Date: Sep. 30, 2010

(54) Optical Article Comprising a Temporary Layer of Aliphatic Thermoplastic Polyurethane and Use in Edging

(75) Inventors: Chefik Habassi, Charenton Le Pont (FR); Matthieu Koscher, Charenton Le Pont (FR)

Correspondence Address: FULBRIGHT & JAWORSKI L.L.P., 600 CONGRESS AVE., SUITE 2400, AUSTIN, TX, 78701, US

(73) Assignee: Essilor International (Compagnie Generale D'Optique), Charenton Le Pont (FR)

(21) Appl. No.: 12/744,300

(22) PCT Filed: Nov. 21, 2008
(86) PCT No.: PCT/FR08/52105

§ 371 Date: May 21, 2010

(30) Foreign Application Priority Data
Nov. 23, 2007 (FR) 0759270
Feb. 18, 2008 (FR) 0851022

(51) Int. Cl. B32B 27/28; B05D 5/06; B32B 27/40

(52) U.S. Cl. 428/220; 427/162; 428/423.1; 428/422.8

(57) ABSTRACT

The optical article of the invention is characterized in that it comprises on one of the main surfaces thereof an external hydrophobic and/or oleophobic coating, a dried temporary coating of a composition comprising, preferably consisting in, one or more aliphatic thermoplastic polyurethane(s) having a polyether or polyester backbone directly deposited onto the external hydrophobic and/or oleophobic coating.

Application to ophthalmic lenses.

The field of the present invention relates generally to optical articles, especially to ophthalmic lenses, provided with an external coating having hydrophobic and/or oleophobic properties (top coat).

Such external hydrophobic and/or oleophobic coatings are well known in the art.

The aim of such external hydrophobic and/or oleophobic coatings, which are typically associated with antireflective coatings, is to prevent the ophthalmic lens from getting dirty. It is most of the time a material of the fluorosilane type, which reduces the surface energy so as to keep greasy soils from adhering, thus making them easier to remove.

One of the problems arising from those external hydrophobic and/or oleophobic coatings lies in their efficiency that is high to the point of impairing or even impeding the adhesion at the interface between an adhesive pad and the surface of the hydrophobic and/or oleophobic coating, which adhesion is required for mounting lenses during an edging operation.

Edging is the last finishing step for an ophthalmic lens and does consist in machining the edge or the periphery of the lens so as to conform it to the size and the shape required for adapting the lens to the spectacle frame into which it is intended to be inserted.

Edging is performed on an automated grinder comprising diamond grinding wheels which carry out the hereinabove defined machining and the lens to be edged has thus to be fixedly maintained in the grinder.

For this purpose, the first stage does consist in fixing a chuck in the middle of the convex surface of the lens by means of a pressure-sensitive adhesive pad such as a double-sided adhesive pad, for example an adhesive sticker.

The chuck to which the lens does adhere through said adhesive pad is then mechanically fixed along the mounting axis of the grinder and an axial arm is blocking the lens by applying a central force on the lens side opposite to the chuck.

Upon edging, the lens should not undergo any offset of more than 2°, preferably of maximum 1°, and therefore the pad adhesion to the lens surface is crucial for obtaining a good edging.

To overcome these difficulties in edging lenses that are provided with an external hydrophobic and/or oleophobic coating, it has been proposed to form on such hydrophobic and/or oleophobic coatings a temporary coating, of organic or mineral nature. For example, the European patent applications EP 1 392 613 and EP 1 633 684, to ESSILOR, describe the use of a temporary coating, of organic or mineral nature, which raise the surface energy and thus enables the optician to perform a reliable edging of the lens. After edging, the temporary coating should be removed so as to restore the external hydrophobic and/or oleophobic coating surface properties. It goes without saying that after removal of the temporary coating, the external hydrophobic and/or oleophobic coating should have surface properties as similar as possible as the initial properties.

The patent application US No 2007/141358 describes a method for edging an optical article, wherein the external surface of the article is coated with a temporary protective layer having an organic nature based on fluorinated materials that are able to generate an intermolecular link or to interact with the adhesive material overlying the holding pad surface. The external surface of the article is preferably an antifouling coating, with which the temporary protective layer may interact. This application does not describe any polyurethane-based temporary coating.

If needed, after the main edging operation of the optical article, it may be wished to restart an edging operation and/or a glass drilling, the drilled area acting as a fixing point to a spectacle frame temple.

For these last steps, especially for glass drilling, it is crucial for the chuck-adhesive holding pad assembly to remain in position on the surface of the article, because it represents a mark enabling the positioning of the drills for drilling holes.

The film described in the patent application WO 05/015 270 enables performing the main edging, but it has been systematically observed that the chuck-adhesive holding pad assembly does spontaneously separate within the few seconds following this main edging operation.

From the very beginning of the edging operation, the water sprayed on the article during this edging operation seems to percolate under the temporary film which does wrap around itself. Under such conditions, it then becomes impossible to perform later on a restart of the edging or a glass drilling.

The patent application WO 03/05 7641 describes a lens comprising a hydrophobic and/or oleophobic coating provided with a mono- or a multilayered temporary coating. In addition to providing a potential protection for a lens side, whereas the other side does undergo a treatment using energetic species, such coat may be used for facilitating the edging of the lens. The application describes in particular a temporary bilayered coating composed of an inorganic layer (MgF₂) contacting the hydrophobic and/or oleophobic coating of the lens, and of an organic external layer based on a (meth)acrylic or polyurethane-type latex. Therefore, the organic material temporary film is not deposited directly onto the external hydrophobic and/or oleophobic coating.

It is thus an object of the present invention to provide an optical article, especially an ophthalmic lens, comprising an external hydrophobic and/or oleophobic coating directly coated with a temporary coating which:
after removal of the temporary coating, enables to recover an external hydrophobic and/or oleophobic coating having properties that are almost the same as the initial properties and especially a water static contact angle that is almost the same as the initial one;
if needed, enables to conduct an edging restart operation; and/or
enables to perform a glass drilling, the drilled area acting as a fixing point to a spectacle frame temple.

The objectives of the present invention are aimed at herein with an optical article comprising on one of the main surfaces thereof an external hydrophobic and/or oleophobic coating with a low surface energy, characterized in that a temporary coating of a dried composition comprising an aliphatic thermoplastic polyurethane having a polyether or polyester backbone (aliphatic TPU) in an organic solvent is directly deposited onto the external hydrophobic and/or oleophobic coating.

As used herein an aliphatic thermoplastic polyurethane having a polyether or polyester backbone is intended to mean an aliphatic thermoplastic polyurethane, the main chain of which comprises polyether and/or polyester segments.

Preferably, the dried composition comprises at least 50% by weight of TPU, more preferably 70% by weight, and most preferably more than 90% by weight of TPU.

Preferably, the dried composition consists in an aliphatic thermoplastic polyurethane having a polyether or polyester backbone (aliphatic TPU).

The temporary coating which is preferably strippable, generally has a thickness ranging from 1 to 80 micrometers, preferably from 10 to 60 micrometers, more preferably from 20 to 50 micrometers, and most preferably from 30 to 40 micrometers. It is emphasized that the TPU-based temporary coating of the invention enables edging, when the top coat layer physical thickness does range from 3 to 6 nm or even is twice as thick.

Depending on the method for depositing the temporary coating, the coat thickness may vary locally. In particular, in the case of a dip coating in a liquid coating composition-containing bath, the thickness is higher in the lower part of the glass (which part contacts the temporary coating composition liquid first and leaves the bath last when lifting the glass).

The temporary coating average thickness results from the measurement of three thicknesses effected on 3 points of the surface: two opposed points: an upper point (around 5 mm from the glass periphery), a central point and a lower point (around 5 mm from the glass periphery), in the case of a dip coating.

The average thickness ranges are the same as the hereinabove mentioned thickness ranges.

Preferably, the temporary coating has a surface energy higher than or equal to 15 mJ/m², more preferably higher than or equal to 20 mJ/m², more preferably higher than or equal to 30 mJ/m². Even more preferably, the temporary coating has a surface energy polar component lower than 26 mJ/m².

As used herein, an “optical article” is intended to mean an optically transparent, organic or mineral glass substrate, that has been treated or not depending on whether it comprises one or more coating(s) of various natures or it remains a bare substrate.

Preferably, in the case of ophthalmic lenses the hydrophobic and/or oleophobic coating as well as the temporary coating are deposited on the front face (typically the convex face) of the lens, that is to say on the lens side that is the most distant from the wearer's eye.

Surface energies are calculated according to the OWENS-WENDT method described in the following reference: “Estimation of a surface force energy of polymers” OWENS D. K., WENDT R. G. (1969) J. Appi. POLYM. SCI, 13, 1741-1747.

The optical articles of the invention are optical articles, especially ophthalmic lenses, which comprise an external hydrophobic and/or oleophobic coating and preferably optical articles comprising both an external hydrophobic and/or oleophobic coating deposited onto a mono- or a multilayered antireflective coating.

Indeed, external hydrophobic and/or oleophobic coatings are generally applied onto optical articles comprising an antireflective coating, especially composed of a mineral material, so as to reduce their trend towards fouling, for example towards greasy type deposits.

As is known, external hydrophobic and/or oleophobic coatings are obtained by applying, on the surface of the antireflective coating, compounds reducing the surface energy of the optical article.

Such compounds have been widely described in the prior art, for example in the following patents U.S. Pat. No. 4,410,563, EP 0 203 730, EP 749 021, EP 844 265, and EP 933 377.

Compositions comprising fluorosilanes preferred for preparing hydrophobic and/or oleophobic coatings are described in the U.S. Pat. No. 6,183,872. They comprise fluoropolymers which organic groups do carry silicon based-groups having the following general formula and a molecular weight ranging from 5.10² to 1.10⁵:

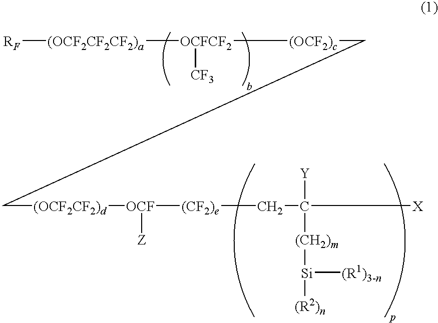

wherein R_{F} represents a perfluoroalkyl group; Z represents a fluoro or a trifluoromethyl group; a, b, c, d and e each represent, independently from each other, 0 or an integer higher than or equal to 1, provided however that the sum of a+b+c+d+e is not less than 1 and that the order of the repeating units in brackets under a, b, c, d and e is not limited to the one illustrated; Y represents H or an alkyl group having from 1 to 4 carbon atoms; X represents a hydrogen, a bromine or an iodine atom; R¹ represents a hydroxyl group or a hydrolyzable group; R² represents a hydrogen atom or a monovalent hydrocarbon group, m is 0, 1 or 2; n is 1, 2 or 3; and p is an integer being at least equal to 1, preferably at least equal to 2.

A composition comprising a fluorosilane having the previously mentioned formula (1) is marketed by the DAIKIN INDUSTRIES company under the trade name OPTOOL DSX®.

This compound is preferred for carrying out the method of the present invention.

Other fluorosilanes to be suitably used for preparing anti-fouling coatings are described in the patents JP 2005-187936 and EP 1 300 433, and do have the following formula:

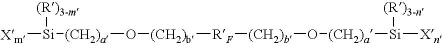

wherein R′_{F} is a linear chain, perfluoropolyether divalent radical, R′ is a C₁-C₄ alkyl radical or a phenyl radical, X′ is a hydrolyzable group, a′ is an integer ranging from 0 to 2, b′ is an integer ranging from 1 to 5, and m′ and n′ are integers equal to 2 or 3.

Commercial compositions enabling hydrophobic and/or oleophobic coatings to be prepared are the KY130® compositions (having the formula as given in the patent JP 2005-187936).

Compounds based on silane carrying fluorinated groups, especially perfluorocarbon or perfluoropolyether groups, are used most of the time.

Suitable examples thereof include silazane- or polysilazane- or silicone-based compounds comprising one or more fluorinated group(s) such as those previously mentioned.

A known method consists in depositing onto the antireflective coating compounds carrying fluorinated groups and Si—R groups, wherein R represents an —OH group or a precursor thereof, preferably an alkoxy group. Such compounds may cause polymerization and/or cross-linking reactions to occur on the surface of the antireflective coating, immediately upon or after hydrolysis.

Applying the compounds reducing the surface energy of the optical article is traditionally effected by dipping into a compound-based solution, by spin-coating or by conducting a chemical vapor deposition in particular.

Generally, the external hydrophobic and/or oleophobic coating is less than 10 nm thick, and more preferably less than 5 nm thick.

Generally, the low surface energy external hydrophobic and/or oleophobic coating has a surface energy lower than or equal to 14 mJ/m², preferably lower than or equal to 13 mJ/m², more preferably lower than or equal to 12 mJ/m².

The optical article of the invention, which is preferably an ophthalmic lens, may comprise on one of the main surfaces thereof other surface coatings between the substrate and the hydrophobic and/or oleophobic coating, especially an impact-resistant primer coating, an abrasion- and/or scratch-resistant and/or an antireflective coating. In a preferred embodiment, the optical article comprises, in addition to the hydrophobic and/or oleophobic coating, an impact-resistant primer coating, and more preferably, an impact-resistant primer coating together with an antireflective coating and the hydrophobic and/or oleophobic coating, in this deposition order on one of the main surfaces thereof.

As previously stated, the temporary coating of the invention is a dried layer of a composition comprising one or more aliphatic thermoplastic polyurethane(s) having a polyether or polyester backbone in an organic solvent or a combination of organic solvents.

Generally, the one or more aliphatic TPU(s) present in the composition represent from 5 to 20%, preferably from 5 to 15% by weight, as related to the total weight of the composition directly deposited onto the external hydrophobic and/or oleophobic coating.

The aliphatic thermoplastic polyurethanes of the invention are the products of the reaction of an aliphatic diisocyanate with an aliphatic polyol.

Suitable aliphatic diisocyanates include hexamethylene-1,6-diisocyanate, isophorone diisocyanate, ethylene diisocyanate, dodecane-1,12-diisocyanate, cyclohexane-1,3-diisocyanate, bis-(4-isocyanato-cyclohexyl)-methane and mixtures thereof.

The preferred polyisocyanate is the following one:

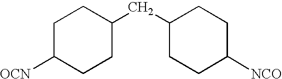

Aliphatic polyols to be suitably used in the present invention are polyols having a polyether or polyester backbone comprising at least two hydroxyl groups, optionally in combination with other polyols, in particular those comprising more than two hydroxyl groups.

The preferred polyols include polyalkylene glycols, in particular polyethylene glycols, polypropylene glycols, polybutylene glycols and mixtures thereof.

The preferred polyethylene glycols correspond to formula HO[CH₂CH₂O]_{n′}H wherein n′ is an integer ranging from 15 to 30, preferably from 19 to 25, and are even more preferably combinations of these polyethylene glycols.

The preferred polybutylene glycols correspond to formula HO[(CH₂)₄O]ₙH wherein n is an integer ranging from 2 to 35, preferably from 3 to 30, more preferably from 4 to 29, and are even more preferably combinations of these polybutylene glycols.

Combinations of such preferred polyethylene glycols and polybutylene glycols are used, in particular such as defined hereinabove, the one or more polybutylene glycol(s) being predominantly present in the mixture.

In an especially preferred embodiment of the TPUs of the invention, said “polyol” is a combination of:
polybutylene glycol of formula HO[(CH₂)₄O]ₙH, wherein n is an integer ranging from 2 to 35, preferably from 3 to 30, more preferably from 4 to 29, said “polybutylene glycol” being the predominant component in the polyol mixture (that is to say representing more than 50% by weight of the whole polyols), and
polyethylene glycol of formula HO[CH₂CH₂O]_{n′}H, wherein n′ is an integer ranging from 15 to 30, preferably from 19 to 25, and the polyisocyanate is preferably as follows:

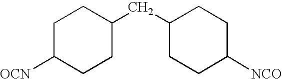

The preferred polyurethane is obtained by making the mixture of preferred polyols react with the hereinabove preferred polyisocyanate.

To the TPU may be added an antiplasticizer in the usual amounts.

The polyols having a polyether or polyester backbone comprising at least two hydroxyl groups do preferably represent at least 50%, more preferably at least 70%, even more preferably at least 90% by mole as related to the whole polyols that are present in the composition, and most preferably 100%.

Typically, the polyols having a polyether or polyester backbone have a molecular weight of about 1000. Polyols having a polyether or polyester backbone with a molecular weight lower or higher than 1000, especially up to 2000 may also be used.

Examples of polyols having a polyether backbone include polytetramethylene glycols, in particular with a molecular weight of about 1000, or mixtures of a diol having a polyether backbone and a polyol having more than two hydroxyl groups, such as a mixture of a glycol and a triol, for example glycerol or trimethylol propane.

Examples of polyols having a polyester backbone include those comprising a dibasic acid such as adipic or glycolic acid, the ester being obtained by esterifying with ethylene glycol, propylene glycol or optionally polyethylene glycol, polypropylene glycol, polybutylene glycol or mixtures thereof. Preferably, the final molecular weight of the polyol having a polyester backbone does not substantially exceed approximately 1000.

As is usual, chain extenders may be used, advantageously short chain-diols, such as ethane diol, propane diol, butane diol and equivalents, provided however that the aliphatic nature of the resulting thermoplastic polyurethane is preserved.

Preferably, the aliphatic thermoplastic polyurethanes of the invention are aliphatic polyurethanes having a polyether backbone, and in particular elastomers.

Such aliphatic thermoplastic polyurethanes are commercially available from the MORTON INTERNATIONAL INC. company under the trade name MORTHANE® or from the BAYER CORPORATION company, Polymers Division, under the trade name TEXIN®.

Examples of commercially available polyether-type backbone, aliphatic polyurethanes include the commercial products of the MORTHANE® series, PE 199-100, PE 193-100, PE 192-100.

Examples of commercially available polyether-type backbone, aliphatic polyurethane elastomers include the products TEXIN® DP7-3006, DP7-3004, DP7-3005, DP7-3007 and DP7-3008.

Examples of commercially available aliphatic polyurethanes having a polyester backbone include MORTHANE® PN3429-100.

Such aliphatic thermoplastic polyurethanes are also described in U.S. Pat. No. 6,170,952.

As already mentioned, in the coating composition, the aliphatic thermoplastic polyurethane or the combination of aliphatic thermoplastic polyurethanes presents as a solution in an organic solvent or a combination of organic solvents. Any organic solvent or combination of organic solvents able to dissolve polyurethane or combination of polyurethanes, may be used. Examples of suitable organic solvents include N-methylpyrrolidone, dimethyl acetamide, chloroform, dimethylformamide, combinations of these solvents or combinations of these solvents with an alkanol such as ethanol. The coating composition may comprise a small amount of water typically less than 10% by weight, preferably less than 5% by weight and even more preferably less than 1% by weight. In a preferred embodiment of the invention, the coating composition is devoid of water.

If needed, the aliphatic thermoplastic polyurethane or the combination of aliphatic thermoplastic polyurethanes may be dispersed in an aqueous solution. As used herein an “aqueous solution” is intended to mean a solution comprising water as a majority solvent, that is to say the solvent comprises at least 50% by weight of water, preferably 70% by weight of water, more preferably 90% by weight of water and even more preferably 100% by weight of water.

The preferred embodiment is the one wherein the aliphatic thermoplastic polyurethane or the combination of aliphatic thermoplastic polyurethanes presents as a solution in an organic solvent or in a mixture of organic solvents.

The temporary coatings of the invention may be deposited onto the hydrophobic and/or oleophobic coating by any type of means, but preferably by dip coating, spin coating, spraying, or by brush coating, preferably by dip coating.

The deposition may be effected on the whole surface of the lens side intended to receive the adhesive holding pad or on part thereof, especially on the central part of the lens.

In an embodiment, the temporary coating may be applied onto the central part by means of a brush.

There is no additional coating on the surface of the temporary coating, i.e. the temporary coating is a monolayer and upon edging, the holding adhesive pad directly comes into contact with the surface of the TPU-based temporary coating.

Preferably, the temporary coating is optically inactive, that is to say it enables measuring the power using traditional measuring means such as a frontofocometer.

Once it has been applied, the aliphatic thermoplastic polyurethane composition of the invention is dried, by heating to temperatures typically ranging from 40° C. to 80° C., generally to about 50° C., for one or more hour(s), generally for about 2 hours.

The good results of the invention are obtained by simply drying without requiring any actinic radiation.

The present invention also relates to a method for edging an ophthalmic lens, comprising a hydrophobic and/or oleophobic coating, preferably deposited onto a mono- or a multilayered antireflective coating, onto which an aliphatic thermoplastic polyurethane-containing temporary coating, such as previously defined, is directly deposited.

The edging method may be optionally followed with an edging restart step and/or with a drilling step.

More precisely, the edging method includes:
obtaining an ophthalmic lens comprising a hydrophobic and/or oleophobic coating onto which an aliphatic thermoplastic polyurethane-containing temporary coating is directly deposited;
fixing the lens to a chuck by means of an adhesive holding pad adhering to the temporary coating surface;
mounting the chuck to which the lens adheres by means of the adhesive holding pad in an edging device;
edging the lens by machining the periphery of the lens so as to conform it to the size and the shape of a spectacle frame; and
once the lens has been recovered, removing the temporary coating, in particular by stripping it off.

As an advantage, the optical articles of the invention are stable over time and little sensitive to their environment. In particular, they are not or little affected by high humidity and temperature conditions.

The following examples illustrate the present invention. In the examples, unless otherwise stated, all parts and percentages herein are expressed in weight.

The lenses onto which the various layers are deposited are thermoplastic lenses made of polycarbonate (PC), having 70 mm diameter, −8 diopter power and +2 cylinder power.

They comprise in accordance with this deposition order: an impact-resistant primer coating (W234®), an abrasion-resistant coating and a mineral-type ZrO₂/SiO₂/ZrO₂/SiO₂ antireflective coating. The top coat layer is then to be deposited onto the SiO₂ last layer (external coat).

1. Deposition of the Hydrophobic and/or Oleophobic Coating (Topcoat)—OPTOOL DSX® from the DAIKIN Company
Conditions for depositing the top coat DSX under vacuum (3×10⁻⁵ mbar=3×10⁻³ Pa); it is the vacuum produced by standard TSV machines:
Programmed thickness=14 nm (deposition thickness from 3 to 5 nm)
   Deposition rate=0.4 nm/sec
   Deposition by Joule heating
   The product in its capsule is heated beforehand on a heating plate to 70° C. for 2 minutes prior to being used
Programmed thickness=25 nm (deposition thickness from 6 to 10 nm)
   The method as a whole remains unchanged as compared to that with the 14 nm thickness.

### 2. Preparation of an Aliphatic Thermoplastic Polyurethane Composition

### Procedure:

introducing 80.00 g of TPU TEXIN DP7-3006 in a polypropylene or a glass beaker;
adding 560.00 g of chloroform to the beaker;
adding 240 g of ethanol to the beaker;
placing the beaker under a RAYNERIE stirrer (VMI) provided with a deflocculating turbine—diameter 35 mm,
starting the stirrer at slow stirring, then gradually increasing the rate up to 1880 rpm (the procedure lasts around half an hour).
covering the solution with an aluminium foil and stirring the solution.

After overnight stirring, a thick solution is obtained.

Filtering this solution is effected by means of a Sartorius 5″ type filter (8 μm).

### 3. Deposition of the Temporary Coating

The temporary coating is deposited by dip coating the lens provided with the top coat:

The lens is maintained by means of a clamp with three points of contact on the edge of the lens.

After vertical dipping into the solution of TPU, the lens is removed vertically from the bath at a rate of 2.27 mm/s.

Once the dipping has been completed, the glass is maintained at 50° C. for at least 2 hours.

Two types of lenses with a temporary coating are obtained: lenses with a 3 to 5 nm-thick top coat and lenses with a 6 to 10 nm-thick top coat. Each of these lenses is submitted to the performance tests as follows.

It should be controlled whether the power of the obtained lenses can be measured using a frontofocometer such as a CLE 60.

In that event, it means that the temporary coating does not affect this measure. It is noted “OK” in the optical reading test, otherwise it is noted “NO”.

### 4. Determination of the Surface Energy Characteristics for the Aliphatic TPU-Containing Temporary Coatings

The surface energy, total energy, dispersive component and polar component characteristics are determined by means of the OWENS-WENDT method using a DIGIDROP GBX apparatus.

### 5. Offset Measuring Procedure for Lenses Submitted to an Edging Operation

a. Test Description

The edging test is performed on an Essilor Kappa grinding machine.

Lenses are edged so as to provide them with a frame template specific shape (see hereunder).

The following equipment is required for the test to be performed:

An Essilor CLE 60 frontofocometer (for glass pointing and final inspection).

Essilor Kappa digital equipment (tracer-blocker-grinder).

Frame template of the Charmant type reference 8320, model 05, size 51.

Pseudo frame for control.

Adhesive sticker or holding adhesive pad LEAP II, 24 mm diameter, GAM200 from the 3M company.

Essilor chuck for receiving the adhesive sticker.

b. Sampling and the Mounting Parameters.

The retained mounting dimensions are as follows:
Height: Half-height boxing i.e.
PD (right and left)=32 mm and axis=90°

The trimming cycle used is a cycle adapted to the material (plastic cycle for low refractive index, polycarbonate cycle for PC and cycle for substrates having a mean refractive index MHI). The retained clamping pressure is the brittle glass pressure option of the grinder.

c. Controls

After edging, controls are performed so as to determine whether the edging operation succeeded.

Controls are performed using the frontofocometer CLE 60 by pointing the lenses held in the pseudo-frame. Axes are registered during this phase.

If the lens, after the edging operation cannot be inserted into the pseudo-frame or if the lens can be inserted into the pseudo-frame, but with an offset of more than 2°, the lens is non-compliant and did not pass the test successfully. It is noted “-” in the result table.

If the glass offset is lower than 2°, the lens passes the test and is noted “OK” in the result table.

### 6. Drilling After Edging

After the edging operation, the lens and chuck/adhesive pad assembly, with the chuck/adhesive pad firmly adhering to the lens is placed in an Optidrill or Minima2 drilling machine and held in position by a blocking device.

The lens is then drilled
either manually with the Minima 2 drilling machine provided with a drill of 2.2 mm diameter, rotating at 3500 rpm,
or automatically with the Optidrill Evo drilling machine provided with a drill of 2.2 mm diameter, rotating at 12000 rpm.

After drilling, the blocking system is unlocked and the drilled lens is recovered together with the chuck/adhesive pad assembly.

Then the chuck is removed and the drilled lens is recovered.

When the lens can be positioned in the drilling device and therefore passes the drilling operation successfully, it is noted “OK” in Table III. If not, it is noted “NO”.

### 7. Measurement of the Water Contact Angle

Measuring the contact angle is effected by means of a goniometer KRUSS reference DSA 10 by depositing 5 droplets of deionized water (4 μl per droplet) on the cleaned and dried surface of the lens, one on the centre thereof and the four others 20 mm away from the latter.

### 8. Caustic Soda Treatment

The caustic soda treatment which is intended to check the hydrophobic and/or oleophobic coating resistance consists in dipping the lens for 30 minutes in a soda solution 0.1N, then in rinsing three times with demineralized water and three times with isopropyl alcohol, drying (by blowing compressed air on both sides of the glass. Checking using a minispot that there are no liquid streaks), measuring the contact angles on the same sides as before the treatment (t=0). The contact angle value corresponds to the average of the results.

The glass is considered as having successfully passed the caustic soda treatment when the contact angle mean values with no soda treatment and after a soda treatment are close to the target values as defined hereunder for a 3-5 nm thick top coat:

| | |
|---|---|
| Nature of the hydrophobic | “water contact angle” (°) |
| and/or oleophobic | target values |

| coating/temporary coating | with no caustic | after a caustic |
|---|---|---|
| removed | soda treatment | soda treatment |
| OPTOOL DSX ® 3 nm | 117°-120° | 113°-114° |
| OPTOOL DSX ® 6 nm | 119° | 116° |

### 9. Durability Tests

The ophthalmic lenses of the invention comprising the temporary coating are placed in paper liners (or ophthalmic bags) made in Landouzy (59000 France) comprising a fibrous pad and they are stored for 3 months in a temperature-regulated (40° C.) and moisture-regulated (80% of humidity) climatic chamber.

At the end of the 3 month-period, the lenses are withdrawn from their liner and a visual inspection is effected.

The inspection is performed by naked eye to control whether fibers have been torn out from the liner and do adhere to the lens surface, and whether the cosmetic appearance of the glass has been changed (streaks or spots occurrence, if any).

If the ophthalmic lens does pass the test successfully, it is noted “OK” in Table II hereunder. If not, it is noted “NO”.

The results are indicated hereunder:

| | | | Drilling after | |
|---|---|---|---|---|
| | Optical reading | Edging | edging | Durability |
| 14 to 25 nm-thick | OK | OK | OK | OK |
| lenses | | | | |
| (programmed | | | | |
| thicknesses) of | | | | |
| Optool DSX with | | | | |
| a temporary | | | | |
| coating | | | | |

All the obtained lenses did pass the optical reading, edging, drilling after edging and durability tests successfully.

As a reminder, in the context of the caustic soda treatment, the reference lens for a 6 to 10 nm-thick top coat, with no temporary coating, gives the following results: the static water contact angle before the soda treatment is 119°. After the treatment, it is 116°.

A test is performed on a lens comprising a 6 to 10 nm-thick top coat and a temporary coating that were deposited according to the hereinabove described method, wherein the temporary coating was moreover allowed to remain in contact with the top coat layer for a week at room temperature, under usual humidity conditions.

After removal of the temporary coating by manual stripping, the initial water static contact angle is measured, and thereafter the caustic soda treatment is carried out and the water static contact angle is measured once again. The following results are obtained:

Initial contact angle: 119.5°

Contact angle after caustic soda treatment (30 minutes): 117°

It can be observed that the lenses treated according to the method of the invention are not affected by the temporary coating.

As an advantage, the temporary coating of the invention may be applied by a liquid deposition route, enables to perform a glass marking on the temporary coating, to preserve the hydrophobic and/or oleophobic coating low surface energy, and allows restarting the edging and/or drilling following the initial edging.

1.-24. (canceled)

25. An optical article comprising on a main surface thereof an external hydrophobic and/or oleophobic coating and a dried temporary coating of a composition comprising one or more aliphatic thermoplastic polyurethane having a polyether or polyester backbone is directly deposited onto the external hydrophobic and/or oleophobic coating.

26. The optical article of claim 25, wherein the composition consists of one or more aliphatic thermoplastic polyurethane having a polyether or polyester backbone.

27. The optical article of claim 25, wherein the aliphatic thermoplastic polyurethane is the product of reaction of one or more aliphatic diisocyanate(s) with one or more aliphatic polyol(s).

28. The optical article of claim 27, wherein the diisocyanate is hexamethylene-1,6-diisocyanate, isophorone diisocyanate, ethylene diisocyanate, dodecane-1,12-diisocyanate, cyclohexane-1,3-diisocyanate, and/or bis-(4-isocyanato-cyclohexyl)-methane.

29. The optical article of claim 27, wherein the aliphatic polyol is a polyol having a polyether or polyester backbone.

30. The optical article of claim 28, wherein the aliphatic polyol having a polyether backbone is an elastomer.

31. The optical article of claim 27, wherein the polyol is a polyethylene glycol, polypropylene glycol, or polybutylene glycol.

32. The optical article of claim 31, wherein the polyol is a combination of one or more polybutylene glycol and one or more polyethylene glycol, the polybutylene glycol(s) being the predominant component(s) in the mixture.

33. The optical article of claim 25, wherein the hydrophobic and/or oleophobic coating has a surface energy lower than or equal to 14 mJ/m².

34. The optical article of claim 33, wherein the hydrophobic and/or oleophobic coating has a surface energy lower than or equal to 12 mJ/m².

35. The optical article of claim 25, wherein the temporary coating has a surface energy higher than or equal to 15 mJ/m².

36. The optical article of claim 35, wherein the temporary coating has a surface energy higher than or equal to 30 mJ/m².

37. The optical article of claim 25, wherein the temporary coating has a surface energy polar component lower than 26 mJ/m².

38. The optical article of claim 25, wherein the temporary coating has a thickness ranging from 1 to 80 micrometers.

39. The optical article of claim 25, wherein the temporary coating is a strippable film.

40. The optical article of claim 25, further defined as an ophthalmic lens.

41. A method for producing an optical article of claim 25, comprising depositing a layer of a the composition comprising one or more aliphatic thermoplastic polyurethane(s) having a polyether or polyester backbone as a solution in an organic solvent or a combination of organic solvents, directly onto the external hydrophobic and/or oleophobic coating of the article and drying the composition.

42. The method of claim 41, wherein the aliphatic thermoplastic polyurethanes are the products of the reaction of one or more aliphatic diisocyanate(s) with one or more aliphatic polyol(s).

43. The method of claim 42, wherein the diisocyanate is hexamethylene-1,6-diisocyanate, isophorone diisocyanate, ethylene diisocyanate, dodecane-1,12-diisocyanate, cyclohexane-1,3-diisocyanate, and/or bis-(4-isocyanato-cyclohexyl)-methane.

44. The method of claim 43, wherein the aliphatic polyols are polyols having a polyether or polyester backbone.

45. The method of claim 41, wherein the composition comprises from 5 to 20% of aliphatic thermoplastic polyurethane as related to the composition total weight.

46. The method of claim 41, wherein the composition comprises less than 10% by weight of water as related to the composition total weight.

47. The method of claim 46, wherein the composition comprises less than 1% by weight of water as related to the composition total weight.

48. The method of claim 47, wherein the composition is devoid of water.

49. A method for edging the ophthalmic lens of claim 40, comprising:
fixing the lens to a chuck with an adhesive holding pad adhering to the temporary coating surface;
mounting the chuck to which the lens adheres to the adhesive holding pad in an edging device;
edging the lens by machining the periphery of the lens to conform it to the size and the shape of a spectacle frame;
removing the lens from the chuck; and
removing the temporary coating from the lens.

50. The method of claim 49, wherein the temporary coating is removed by stripping.

51. The method of claim 49, wherein the adhesive holding pad is an adhesive sticker.
